(19) United States
(12) Patent Application Publication
(10) Pub. No.: US 2014/0089322 A1
(43) Pub. Date: Mar. 27, 2014

(54) System And Method for Ranking Creator Endorsements

(71) Applicant: Grail Inc., Marina del Rey, CA (US)

(72) Inventors: Eric Garcia, Venice, CA (US); Lubos Steskal, Bergen (NO); Ryan Magnussen, Los Angeles, CA (US)

(73) Assignee: Grail Inc., Marina del Rey, CA (US)

(21) Appl. No.: 14/028,476

(22) Filed: Sep. 16, 2013

Related U.S. Application Data
(60) Provisional application No. 61/701,440, filed on Sep. 14, 2012.

(51) Int. Cl. G06F 17/30

(52) U.S. Cl. CPC G06F 17/30595
USPC 707/748

(57) ABSTRACT

A system and method for ranking content creators are described. The method for ranking content creators may comprises collecting endorsements associated with a content creator; qualifying the authors of the endorsements; building a creator network, applying an endorsement weighting function to the endorsements; assigning a score to the content creators; and ordering a collection of content items based on the items' assigned score. The identities of content creators are verified by matching content creators in a database to a publicly available online profile. Creators are entered into a creator network consisting of an edges and nodes graph and a weighting function is applied, resulting in a fixed-point score for each creator in the network. These fixed-point scores are inherited by content items produced by the creators and may be used to order a collection of content items pulled from a database.

### CROSS REFERENCE TO RELATED APPLICATIONS

This application claims the benefit under 35 USC 119(e) and 120 to U.S. Provisional Patent Application Ser. No. 61/701,440, filed Sep. 14, 2012, the entirety of which is incorporated herein by reference.

### FIELD

This disclosure general relates to a system and method for ranking content using content creator endorsements harvested from social media.

### DESCRIPTION OF THE RELATED ART

Generally, current systems and methods of ranking online content focus on measuring links inbound and outbound links from websites or webpages, and using algorithms to determine the relative importance of the website or webpage based on the number of links (e.g., PageRank). However, this type of ranking method is problematic, in that it is easily manipulated (e.g., through search engine optimization practices) and does not necessarily return the best content or content that is the most relevant to what the user is seeking.

It is desirable to provide a system and method for ranking content based on authors endorsements, which users to quickly locate and find relevant, quality content. The benefits of this ranking system and method are twofold—a peer review system for authors is created, allowing users to gauge how influential certain content creators are in their community; and, it allows users to easily locate influential content creators, who are likely producing better content. Thus, it is desirable to provide a system and method for ranking content based on endorsements of the content creator.

### SUMMARY

A system and method for ranking creators of online content items are provided. This system and method collects creator endorsements of other content creators and then qualifies the endorser through a verification process where a creator is matched to a publicly available online presence. Then the method and system also includes building a content creator network mapping content creators from a database and their endorsements and then applying an endorsement weighting function to the collected endorsements. The content creators in the creator network are assigned fixed-point scores as a result of the endorsement weighting function. Content items created by content creators in the creator network inherit the fixed-point score assigned to the content creator that created that particular content item. The fixed-point scores inherited by the content items are used to order a selection of content items pulled from the database, which may be accomplished by pulling the content items into a filter based on the content items' properties. The ordering of content items may be surfaced to a user through a website in the form of content rankings based on the rank of the content creator.

Alternatively, the content creator network may be comprised of an edges and nodes graph, with each node representing a content creator in the network and each edge connecting two nodes as a representation of the number of endorsements between two particular content creators. The content creators and their endorsements may be entered into a matrix, where the endorsement weighting function is a non-decreasing function of the number of endorsements made.

### BRIEF DESCRIPTION OF THE DRAWINGS

FIG. 1 is an example of a larger content delivery system of which the endorsement ranking system and method may be a part, according to one embodiment;

FIG. 2 is an example of a larger systems architecture of which the creator endorsement ranking system and method may be a part, according to one embodiment;

FIG. 3 is an exemplary diagram of the process of harvesting creator endorsements in order to rank a group of content items, according to one embodiment;

FIG. 4 is an exemplary social media platform from which an endorsement may be collected, according to one embodiment;

FIG. 5 is an exemplary diagram of a creator network edges and nodes graph, according to one embodiment;

FIG. 6 is an exemplary matrix containing data from the nodes and edges of the creator network graph, according to one embodiment;

FIG. 7 is an exemplary diagram illustrating how fixed-point scores assigned to content creators are used to rank content items produced by those particular creators, according to one embodiment;

FIG. 8 is an exemplary diagram illustrating a how a filter is used to create a collection of content items, according to one embodiment;

FIG. 9 is an exemplary user interface that may be used to surface content rankings to users of a website, according to one embodiment.

### DETAILED DESCRIPTION OF ONE OR MORE EMBODIMENTS

Some portions of the detailed descriptions that follow are presented in terms of algorithms and sequences of operations, which are performed within a computer memory or distributed within a computer system. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

It should be borne in mind, however, that all of these and similar terms are to be associated with the appropriate physical quantities and are merely convenient labels applied to these quantities. Unless specifically stated otherwise, it is appreciated that throughout the description discussion utilizing terms, such as “processing”, “computing”, “calculating”, “determining” or “displaying” and the like, refer to the actions and processes of a computer or a network of computer systems or similar electronic devices that manipulate and transform data represented as physical (electronic) quantities within the computer or computer network's registers and memories into other data similarly represented as physical quantities within the electronic device's memory or registers or other such information storage, transmission or display devices.

The embodiments disclosed also relate to an apparatus for performing the operations described in this disclosure. This apparatus may be specially constructed for the required purposes, or it may comprise a general-purpose processor selectively activated or reconfigured by a computer program stored in the electronic device. Such a computer program may be stored in a computer-readable storage medium, such as any type of disk, including floppy disks, optical disks, CD-ROMs, and magnetic-optical disks, read-only memories (ROMs), random access memories (RAMs), EPROMs, Flash memory, magnetic or optical cards, or any type of media suitable for storing electronic instructions, and each coupled to a computer system bus.

The algorithms presented in this disclosure are not inherently related to any particular electronic device or apparatus. Various general-purpose systems may be used with programs in accordance with the teaching described in this disclosure, or it may prove convenient to construct a more specialized apparatus to perform the required method steps. The required structure for a variety of these systems will appear from the description below. It will be appreciated that a variety of programming languages may be used to implement the teaching of the embodiments described in this disclosure.

Moreover, the various features of the representative examples and the dependent claims may be combined in ways that are not specifically and explicitly enumerated in order to provide useful, additional embodiments of the present teachings. It is also expressly noted that all value ranges or indications of groups of entities disclose every possible intermediate value or intermediate entity for the purpose of original disclosure, as well as for the purpose of restricting claimed subject matter. It is also expressly noted that the dimensions and the shapes of the components shown in the figures are designed to help understand how the present teachings are practiced, but not intended to limit the dimensions and the shapes shown in the examples.

For the purposes of this disclosure, the term “content item” is used broadly to encompass any product of category of creative work including any work that is in an electronic form that is renderable, experiencable, retrievable, computer-readable filed and/or stored in memory, either singly or collectively. Individual items of content or media include songs, tracks, pictures, images, movies, articles, books, ratings, reviews, descriptive tags, or computer-readable files. However, the use of any one term is not be considered limiting as the concepts, features and functions described in this disclosure are generally intended to apply to any work that may be experienced by a user, whether aurally, visually or otherwise, in any manner known or to become known. Further, the terms “content” or “media” includes audio, video and products embodying the same. As mentioned above, while there are many digital forms and standards for audio, video, digital or analog media data and content, embodiments or the systems and methods described in this disclosure may be equally adapted to any format or standard now known or to become known.

In one embodiment, the system may be implemented in one or more functional modules. As used throughout the disclosure, the term module refers to logic embedded in hardware or firmware, or to a collection of software instructions, possibly having entry and exit points, written in a programming language, such as Java. A software module may be compiled and linked in to an executable program, or installed in a dynamic link library, or may be written in an interpretive language, such as Python. It will be appreciated that software modules may be callable from other modules, and/or may be invoked in response to detected events or interrupts. Software instructions may be imbedded in firmware, such as an EMPROM. It will be further appreciated that hardware modules may be comprised of connected logic units, such as gates and flip-flops, and/or may be comprised of programmable units, such as programmable gate arrays. The modules described in this disclosure are preferably implemented as software modules, but cold be implemented as hardware or firmware.

In one embodiment, each module is provided in modular code, where the code typically interacts through a set of standardized function cells. In one embodiment, the code is written in a suitable software language such as Java, but the code may be written in any low-level or high-level programming language. In one embodiment, the code modules are implemented in Java and distributed on a server, such as Microsoft IIS or Linux Apache. Alternatively, the code modules can be compiled with their own front-end on a kiosk, or can be compiled on a cluster of server machines serving interactive television content through a cable, packet, telephone, satellite, or other telecommunications network. Artisans of skill in the art will recognize that any number of implementations, including code implementations directly to hardware, are also possible.

For example, the system may include a database. As is well known, the database categories listed above can be combined, further divided or cross-related, and any combination of databases and the like can be provided from within a server. In one embodiment, any portion of the databases can be provided externally from the website, either locally on the server, or remotely over a network. The external data from an external database can be provided in any standardized form, which the server can understand. For example, an external database at a provider may provide end-user data in response to requests from the server in a standard format, such as user name, user identification, computer identification number, and the like, and the end-user data blocks are transformed by a database management module into a function call format, which the code modules can understand. The database management module may be a standard SQL server, where dynamic requests from the server build forms from the various databases used by the website as well as store and retrieve related data on the various databases.

As can be appreciated, the databases may be used to store, arrange and retrieve data. The databases may be storage devices such as machine-readable mediums, which may be any mechanism that provides (i.e., stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, a machine-readable medium may also comprise computer storage media and communication media. A machine-readable medium also includes volatile and non-volatile, removable and non-removable media implemented in any method or technology for the storage of information, such as computer-readable instructions, data structures, programs modules or other data. A machine-readable medium also includes, but is not limited to, RAM, ROM, EPROM, EEPROM, flash memory or other solid state memory technology, CD-ROM, DVD or other optical storage, magnetic cassettes, magnetic tape, magnetic disk storage or other magnetic storage devices, or any other medium that can be used to store the desired information and that can be accessed by a computer.

According to a feature of the present disclosure, a machine-readable medium is disclosed. The machine-readable medium provides instructions, which when read by a processor, cause the machine to perform operations described or illustrated in this disclosure. The machine-readable medium may be any mechanism that provides (i.e., stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

In one embodiment, the system and method described in this disclosure ranks creators of online content items by the number of endorsements of a content creator or the items of content they have created. As used in this disclosure, the term “endorsement” refers to any social media or social network (e.g., Facebook or Twitter) connection between the endorser and the endorsee, including, but not limited to, mentions of the endorsee's name, link or comments referring to an endorsee or content they produce, persons or entities who follow an endorsee on a social network, and persons or entities who “like” an endorsee's profile or content items posted on a social network. These endorsements are collected by the system and method and used to produce a numerical ranking for each content creator. This numerical ranking is used to influence a collection of content items produced by a closed corpus of content creators.

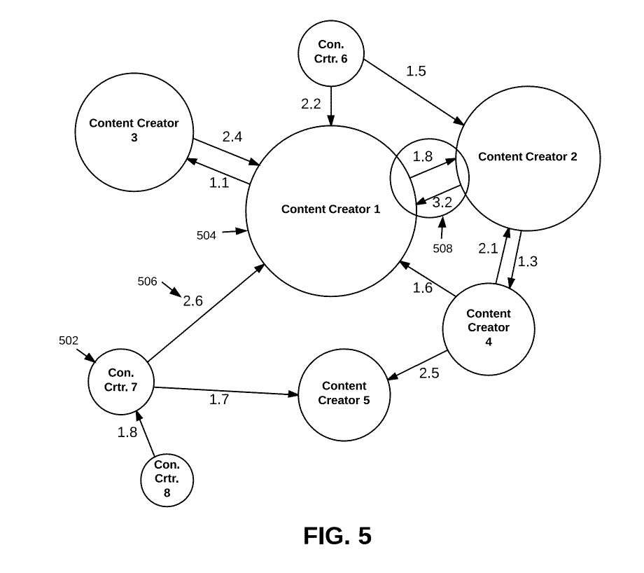

For the purposes of this disclosure, the term “content creator” may refer to any person involved in the production of written documents, images, videos, sound files or any other type of online media or content. While the term content creator as used in this discloser refers to a person, this is not intended to limit what constitutes a content creator. A content creator may also be an entity, such as a publisher, a company, or a group. Additionally, for the purposes of this disclosure, the term “social media citations” may refer to a plurality of endorsement types, including, but not limited to, a direct link to a content item attributed to a content creator, a “mention” of a content creator's name or handle (e.g., a post on a social media site where the content creator is mentioned by name or a content creator's social network user profile name is included in the post), a link to a resource that primarily highlights content attributed to a content creator, etc. Furthermore, an endorsement weight for a creator may be the endorsements that the particular creator has received such as is shown in FIG. 5.

In one implementation, the system and method may use an iterative algorithm to determine a fixed-point score (i.e., the numerical score) for content creators in a corpus of documents. Specifically, given the n×n matrix M of endorsement weights where n is the total number of content creators in the corpus or database and Mᵢⱼ is the endorsement weight from ith content creator to the jth content creator, the endorsement score for content creator j is given by:

$$R ( j ) = ( 1 - d ) + d {\sum }_{i = 1}^{n} ( \frac{Mij}{{\sum }_{j = 1}^{n} Mij} ) R ( i ) \qquad ( 1 )$$

This algorithm approximates the eigen decomposition of a matrix, and the eigenvector associated with the largest positive eigenvalue is retained as the vector of fixed-point scores for a corpus of content creators. Fixed-point scores may be used to rank content creators in a corpus so that a collection of content items produced by those creators may be ordered.

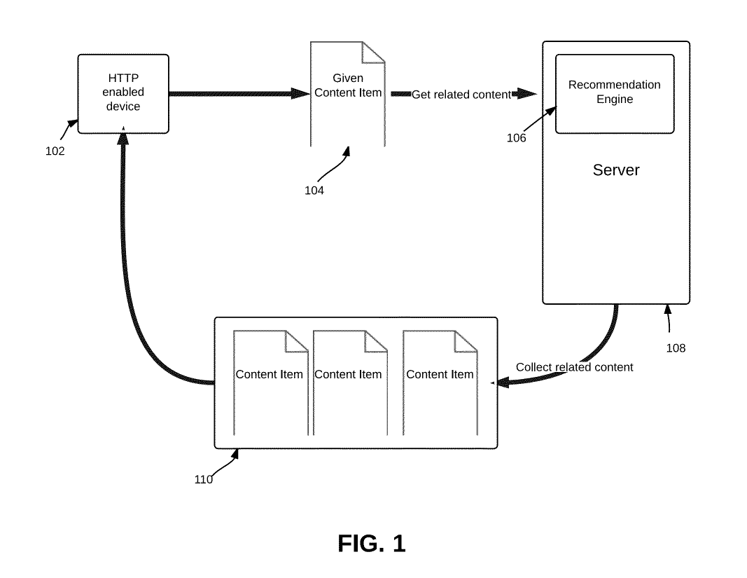

A system and method for delivery content items to a client device, of which the creator endorsement ranking system and method may be a part, is shown in FIG. 1. In the system, one or more HTTP enabled devices 102 may send a client request for content items related to a given content item 104 to a backend component 108 housing a recommendation engine 106 through a website interface, a browser interface or mobile application interface. Each HTTP enabled device 102 may be a processing unit based device that can communicate using the HTTP protocol, such as an Apple iPhone, Android device, personal computer, tablet computer and the like. The system also has a link (that may be a wireless or wired link) that allows the one or more HTTP enabled devices 102 to communicate with a backend system 108. In one implementation, the backend component 108 may be implemented as one or more server computers or one or more cloud computing resources and the functions and processes described below may be implemented in a plurality of lines of computer code that may be stored in a memory and executed by a processor of the backend component 108 or in the recommendation engine 106 that may also be implemented in a plurality of lines of computer code that may be stored in a memory and executed by a processor of the backend component 108. The backend component 108 housing the recommendation engine 106 returns the client request by posting related content items 110 that are accessed by the client device through a website or mobile interface. The recommendation engine 108 may use a plurality of methods to determine how content items are related to each other, including the content creator endorsement ranking method described in this disclosure.

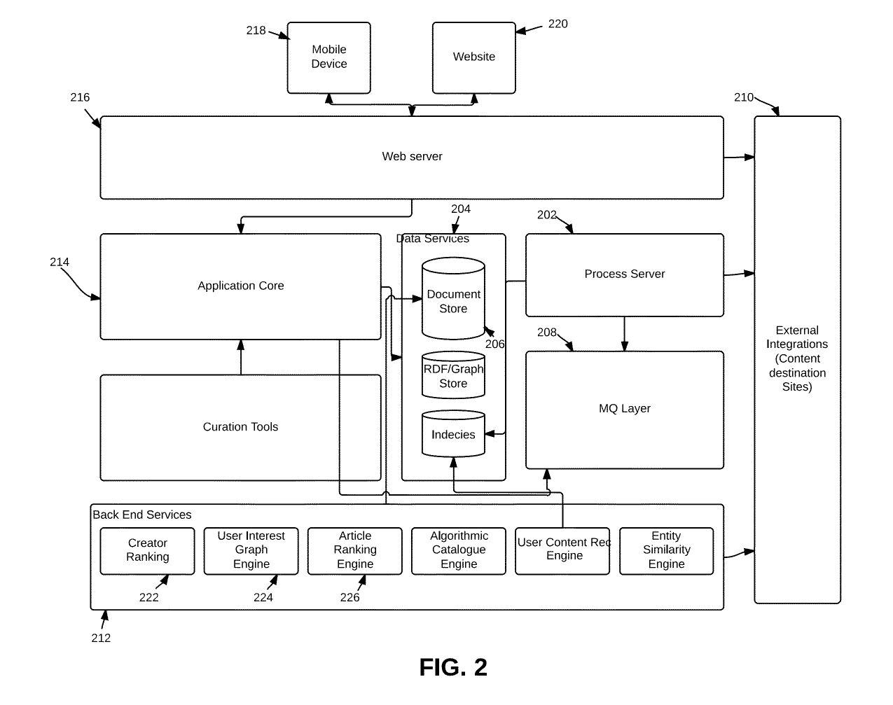

A larger systems architecture of which the creator endorsement ranking system and method may be a part is shown in FIG. 2. A process server 202 ingests and extracts explicit and implicit metadata. The data services component 204 is a persistence layer that stores all of the information for all the systems. Internal curation tools are used for performing quality assurance on information contained in the document store 206. The message queue layer 208 (Q Layer”) is the communication pipeline for the various modules in the architecture. External integrations 210 are externally hosted sources of data (RSS feed aggregators, content destination websites, social networks, etc.). Back-end services 212 consist of processes (such as the creator ranking system and method 222, a user interest graph engine 224, and article ranking engine 226, etc.) that continuously compute relationships in the data 204 and document stores 206, resulting in the enrichment of data in those stores. House within the back-end services 212 is the content creator endorsement ranking system 222, which assists other processes in the back-end services in data enrichment. The applications core 214, hosted by the web server 216, takes information from all the services contained in the architecture and surfaces that information to one or more users through a mobile platform 218 or a website 220. Each of the components of the system shown in FIG. 2 may be implemented using one or more computing resources, such as one or more server computers or one or more cloud computing resources, in which each of the components may be implemented using a plurality of lines of computer code that may be stored in a memory/persistent storage of the one or more computing resources and may be executed by a processor of the one or more computing resources.

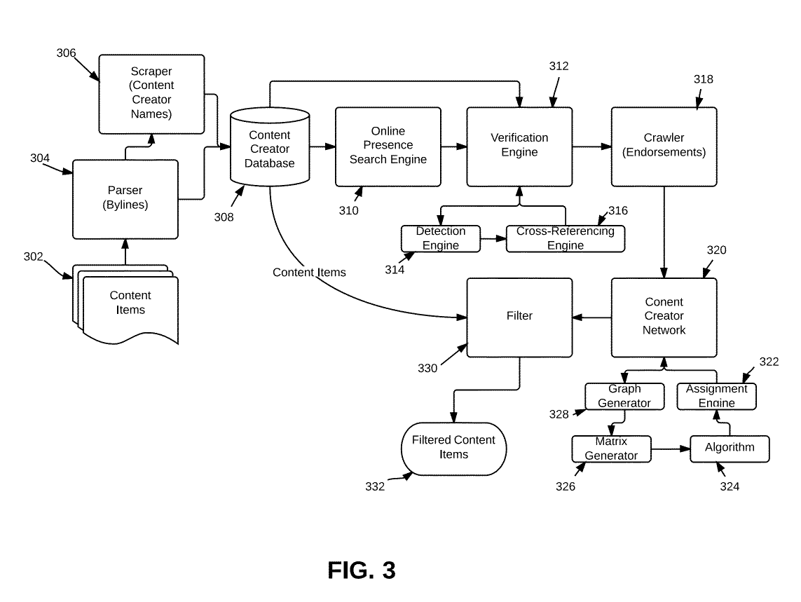

The process of gathering content creators and their endorsements for the content creator database is shown in FIG. 3. Content creators are discovered by using a parser 304 to parse bylines from collected content items 302 published in popular online sources. The names of the content creators and the name of the content items itself are scraped 306 and stored in the content creator database 308. A search engine 310 is used in conjunction with the extracted content creator name in order to discover possible sources of a publicly available “online presence”. As used throughout this disclosure, the term “online presence” refers to a profile typically associated with short-form commentary written by the content creator who is the subject of the online presence inquiry. From a list of possible online presences, a verification engine 312 is used to determine whether the content creator in question is the actual owner of the online presence. A detection engine 314 is used to locate any links that may be present from the online presence to verified content items created by the content creator in question. If links to verified content are detected, the content creator's ownership of the online presence is established.

However, if no links to verified content are found, the online presence may still be verified through use of a facial recognition algorithm. The facial recognition algorithm is used for verification if there exists a profile image on both the publisher's website for the unverified content item and the online presence in question. The facial recognition algorithm compares the entities in each photo—a strong match between the entities will establish ownership of the online presence in question. Once the online presence of the content creator is established, entities linked to the online presence are cross-referenced 316 against the existing database of content creators 308 in order to determine if there are any other verified content creators published by the same publication outlets as the content creator in question.

Given a collection of verified content creators and their associated online presences, the commentary of each online presence is mined by a crawler 318 for other content creator names, the online content items they have created, their online presence and the like. Any reference found by the crawler is considered to be an “endorsement” of that content creator. The content creators and along with any collected endorsements of the content creators, are entered into the creator network edges and nodes graph 320, generated by a graph generator 328, with the edges in the graph representing endorsements and the nodes in the graph representing content creators. Information contained in the graph is entered into an N×N matrix 326, where an iterative algorithm 324 approximates the eigen decomposition of the matrix. The largest possible eigenvalue is determined and its associated eigenvector from the network. The numerical values in this eigenvector serve as serve as an importance ranking of the content creators, and are assigned to individual content creators by an assignment engine 324. Each of the components of the system shown in FIG. 3 may be implemented using one or more computing resources, such as one or more server computers or one or more cloud computing resources, in which each of the components may be implemented using a plurality of lines of computer code that may be stored in a memory/persistent storage of the one or more computing resources and may be executed by a processor of the one or more computing resources.

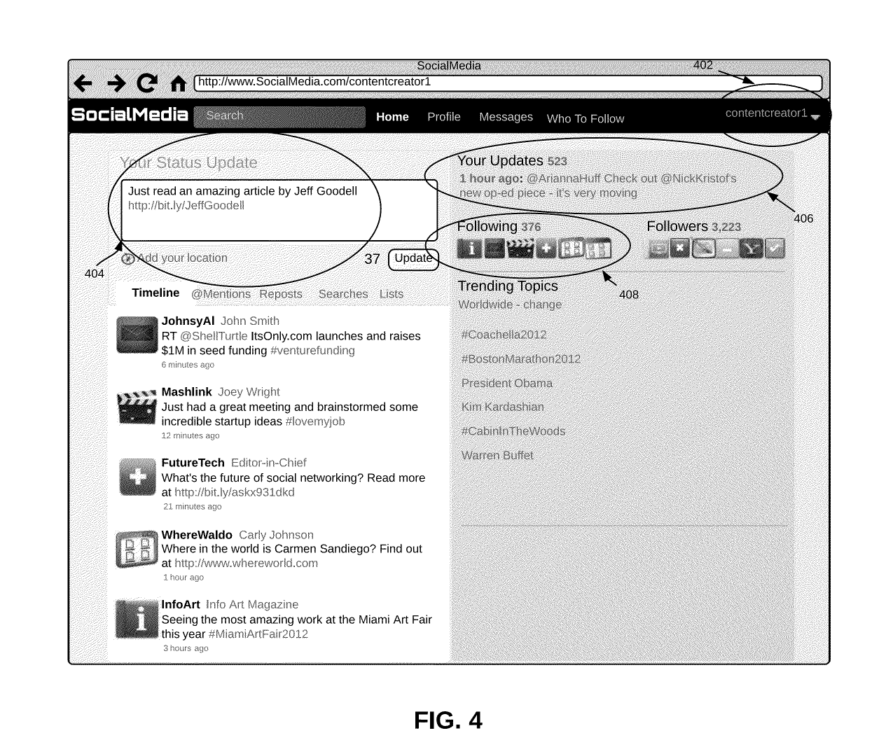

The content creator endorsements may be harvested from social networks (e.g., Facebook), social media platforms (e.g., Twitter), social content sharing services (e.g., Digg), weblogs, personal websites, instant messages, email messages, and any other online or electronic sources that may contain endorsements. In FIG. 4, a sample social media platform from which endorsements may be collected is shown. Here, a sample content creator social media user profile is illustrated (“Content Creator 1”) that demonstrates a plurality of ways of endorsing another content creator. Using their social media user account, a content creator 402 may endorse another content creator by creating a hyperlink featuring a content items created by the endorsee 404. Another way a content creator may endorse another content creator is by creating a post containing the endorsee's social media user name 406. Yet another way a content creator may endorse another content creator is by explicitly “following” the endorsee 408 in a social platform or network, such as Twitter or Facebook. It is important to note that the endorsing party and the endorsee must both qualify as content creator in order for the endorsement to be valid, meaning both parties must be involved in the production of content items or other types of online media.

In on embodiment, these types of endorsements are collected by the system and method described in this disclosure in order to construct a content creator network. The content creator network comprises an edges and nodes graph of all the content creators in a corpus, shown in FIG. 5. The edges and nodes graph is a directed graph, wherein each node represents a different content creator and each edge between the nodes represents one or more endorsements from one content creator to another. The endorsements are represented as directional arrows, with the arrow starting at the endorsing content creator node and ending at the endorsed content creator node. Here, one content creator 502 (“Content Creator 7”) has endorsed another content creator 504 (“Content Creator 1”). The number accompanying the directional arrow representing the one or more endorsements between these two content creators 506 is an output of an endorsement weighting function that is a non-decreasing function of the number of endorsements made.

For example, the weighting function for one or more endorsements between two content creators is log(x+1), where x is the number of endorsements from the endorsing content creator 502 to the endorsed content creator 504. The endorsing content creator 502 has endorsed the endorsee 504 twelve times, so the endorsement weight 506 between the two content creators is 2.6. When two or more content creators are involved in the creation of a content item, a collaborative relationship is formed between all the content creators involved. A collaborative relationship is illustrated in FIG. 5 as a pair of bi-directional arrows 508 between two content creators—the pair being treated as a pair of mutual endorsements. Here, content creator 1 has endorsed content creator 2, and vice versa 508. Additionally, for the purpose of this example, the size of the creator node is representative of the relative level of importance of that particular content creator. The larger the node, the more influence the content creator has in the creator network. Because content creator 1 is the most endorsed creator in the network, that particular content creator is represented as the largest node in this example.

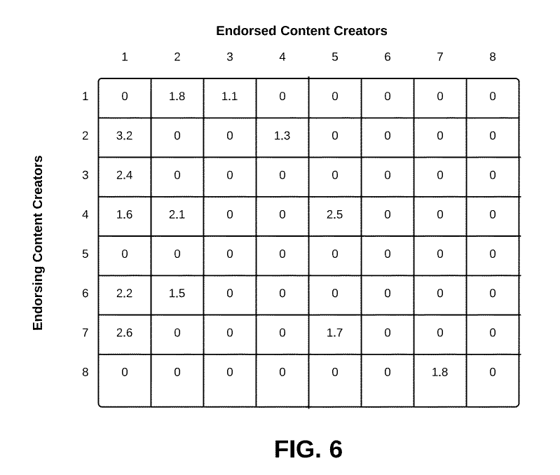

The information contained in the edges and nodes creator network is inputted into a N×N matrix, shown in FIG. 6, where N is the total number of content creators in the creator network 602, and the entry in row i, column j. is the endorsement weight from the i-th creator (endorsing content creator) to the j-th creator (endorsed content creator). The eigen decomposition of the N×N matrix is approximated by the algorithm described above, and the eigenvector associated with the largest positive eigenvalue is retained as the vector of fixed-point scores for the content creators.

The fixed-point score assigned to each content creator in the creator network is used to rank content items, which are contained in a database, attributed to content creators in the creator network. In one implementation, the system and method may use an iterative algorithm to determine a fixed-point score (i.e., the numerical score) for content creators in a corpus of documents. Specifically, given the n×n matrix M of endorsement weights where n is the total number of content creators in the corpus or database and Mᵢⱼ is the endorsement weight from ith content creator to the jth content creator, the endorsement score for content creator j is given by:

$$R ( j ) = ( 1 - d ) + d {\sum }_{i = 1}^{n} ( \frac{Mij}{{\sum }_{j = 1}^{n} Mij} ) R ( i ) \qquad ( 1 )$$

This algorithm approximates the eigen decomposition of a matrix, and the eigenvector associated with the largest positive eigenvalue is retained as the vector of fixed-point scores for a corpus of content creators. Fixed-point scores may be used to rank content creators in a corpus so that a collection of content items produced by those creators may be ordered. Using the method, content items produced by ranked content creators in the content creator network “inherit” the fixed-point score ranking of their creator. Thus, if a content creator has a fixed-point score ranking of 2.6, any content items produced by that content creator also have a fixed-point score ranking of 2.6. In one implementation, the endorsement weighting function may be a non-decreasing function of the number of endorsements made.

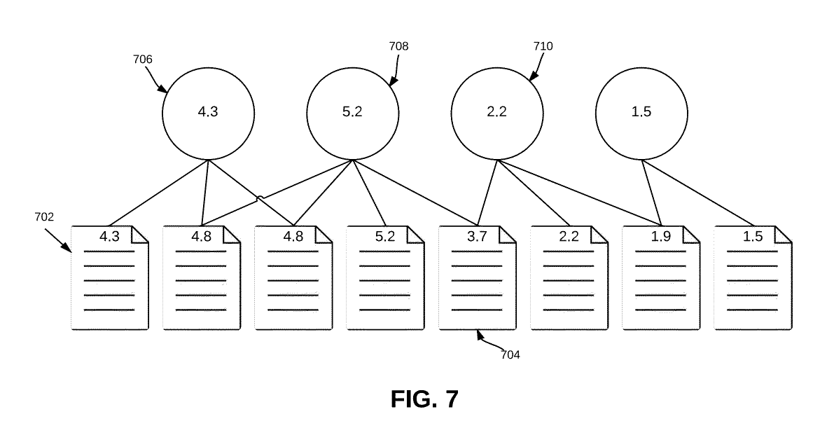

This method is illustrated in detail in FIG. 7. As shown in FIG. 7, four content creators (the circles in the diagram) from a corpus are shown, each represented by a different node containing their fixed-point score (4.3, 5.2, etc.). The score is inherited by each content item stored in the database created by individual content creators in the creator network. For example, a content item 702 inherits its creator's 706 score of 4.3, and that score is used to rank the content item within a collection of content items.

In another embodiment, when a content item has multiple creators and is the product of collaboration, then the score assigned to the content item is an aggregate (for example, calculating the aggregate score as a median, mean, weighted sum, etc.) of the scores of all of the content creators who participated in the creation of the content item. For example, content item 704 has a score (3.7) that is the mean of the content item's two creators' fixed-point scores, 5.2 708 and 2.2 710. Collaborative scores are treated exactly like individual scores for the purposes of ranking content items.

After each content item is assigned a fixed-point score, selected content items are pulled into a filter 330 as shown in FIG. 3. The filter may comprise a plurality of filter types, such as, behavior filters, user profile or information filters, demographic filters, temporal filters, geo-spatial filters, and any other types of filters. The type of filter that is used is based on the on the properties of the content item being pulled into the filter. For example, content items that address a certain geolocation, such as local news, may be pulled into a filter that filters content items by that same geolocation.

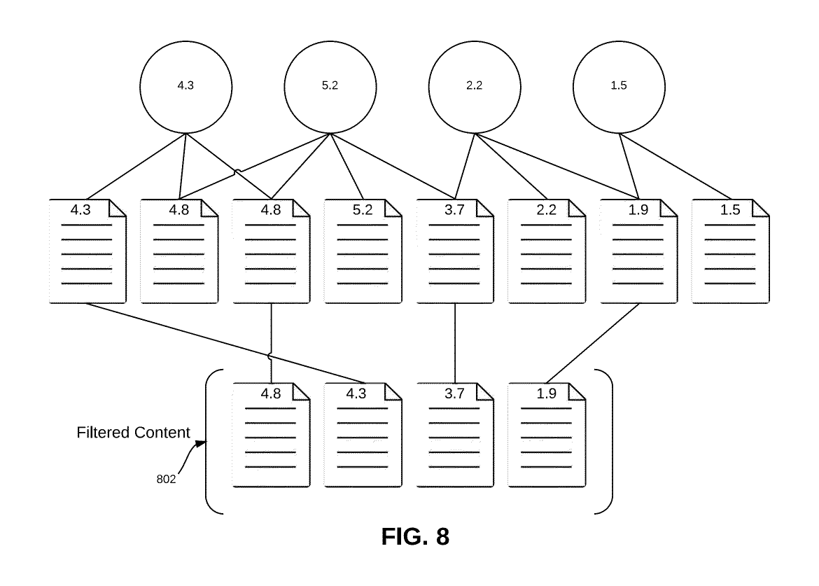

FIG. 8 illustrates certain content items created by content creators in the creator network are pulled from a larger collection of content items (such as content items stored in a database) into a filter. The select content items pulled into the filter are then ordered 802 (i.e., ranked) according to the content item's fixed-point score inherited from the creator of the content item. Here, content items with scores ranging from 4.8 to 1.9 are pulled into a filter and grouped 802. Within the grouping, they are ordered from the content item with the highest score to the content item with the lowest score. Thus, the fixed-point scores of the content items inherited from their creator follow the item and allow the item to be ranked with other content items no matter the context of the group of filtered content items.

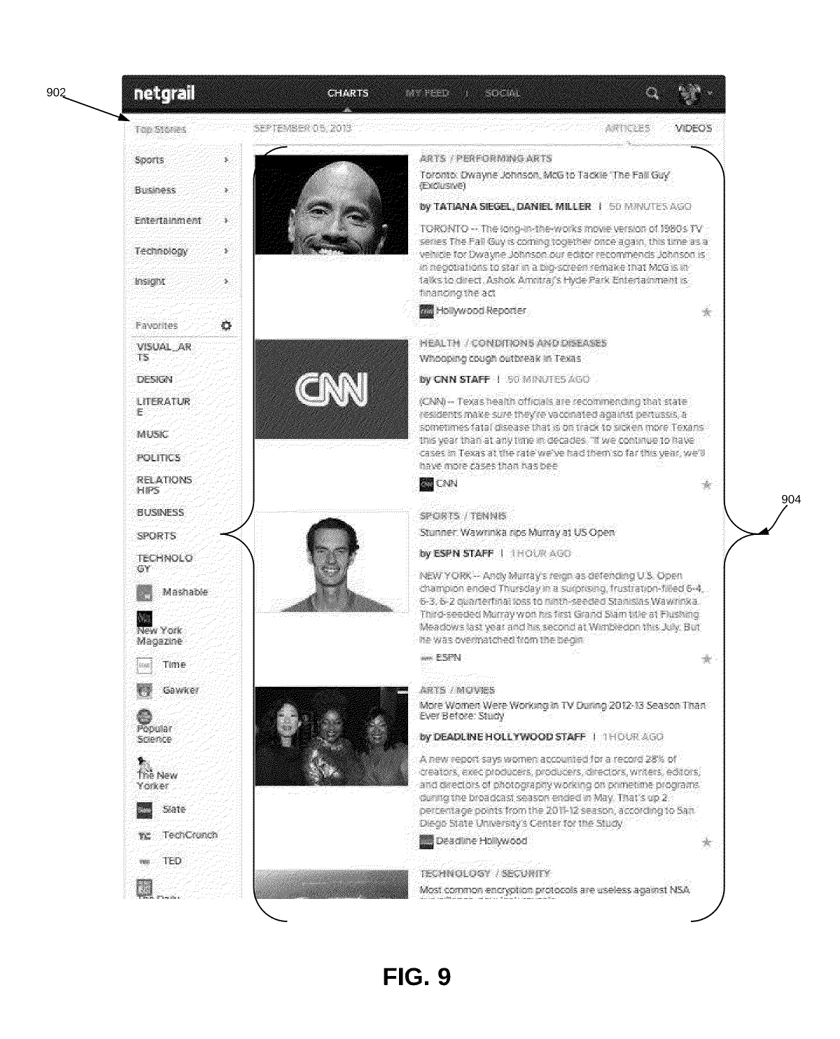

In one embodiment, the ordering of a group of content items may be surfaced on a website for relevance or recommendation purposes. It may be used to rank content items for users in particular categories, or related to certain characteristics, and may be surfaced on a website for a user, such as a content recommendations website. User accessing a content recommendation website may be recommended content items based on the ranking's relevance to the users preferences. A sample content recommendation website is illustrated in FIG. 9. Here, a feed of content items 904 that have been filtered and ranked are shown. These items have been pulled from a corpus in a database and filtered according to their popularity 902 (i.e., “Top Stories”). Within the filter of “Top Stories”, the scores of the content items and their creators may be used to order the items by quality, or by another type of ranking or characteristic.

In the preferred embodiment of the system and method described in this disclosure, content creator endorsements are harvested from social media websites and networks and are used to rank content creators according to their relative level of importance, quality or relevance. Each content creator is assigned a numerical value (i.e., score) indicating the importance of that particular content creator and the quality of content produced by that content creator. Additionally, the numerical value may also indicate the level of relevance of that particular content creator to a user, based on a user's interests, tastes and preferences. The creator endorsement scores are inherited by content items produced by the creators, and may be used to order a collection of these content items according to their fixed-point score.

Embodiments of the content creator rankings methods and systems described herein have numerous applications. For example, such methods and systems may be part of a search engine feature to help provide more relevant, higher quality results in response to a search query. In another embodiment, the systems and methods described herein may be part of a webpage or website to help rank content. In yet another embodiment, the systems and methods described herein may be leveraged into trending charts in order to display the most popular content to users. In yet a further embodiment, the systems and methods described herein may be leveraged into charts displaying content containing the same topic. In yet another embodiment, the systems and methods described herein may be leveraged into charts to display popular content that falls into the same category. In yet a further embodiment, the systems and methods described herein may be used to match content to tracked user preferences and interests. This competitive type implementation may be a contest type website or simply a website trying to provide the best most interesting content on the Internet or some portion thereof.

While the foregoing has been with reference to a particular embodiment of the invention, it will be appreciated by those skilled in the art that changes in this embodiment may be made without departing from the spirit and the principles of the disclosure, the scope of which is defined by the appended claims.

1. A method for ranking content creators, the method comprising:
collecting, using a computer-based system, endorsements associated with one or more content creators;
qualifying, using a computer-based system, the endorsing entity;
building, using a computer-based system, a creator network;
applying, using a computer-based system, an endorsement weighting function to the collected endorsements;
assigning, using a computer-based system, a score to the content creators in the creator network;
assigning, using a computer-based system, content creator scores to the content items produced by one or more creators; and
ordering, using a computer-based system, a collection of content items based on the assigned score.

2. The method of claim 1, further comprising verifying the content creator's identities by matching content creators in a database to a publicly available online profile.

3. The method of claim 1, wherein building the creator network further comprises entering endorsements and content creators into a graph in the form of edges and nodes.

4. The method of claim 1, wherein information contained in the creator network is entered into a matrix.

5. The method of claim 1, the endorsement weighting function is a non-decreasing function of the number of endorsements made.

6. The method of claim 1, wherein ordering a collection of a plurality of content items further comprises pulling content items into a filter based on the content items' properties.

7. A system of ranking content creators, the system comprising:
a processor;
a storage device coupled to the processor;
an index stored in the storage device;
a content creator discovery engine that discovers a content creator;
a content creator verification engine that verifies each content creator;
a content creator network generator that generates a content creator network based on the verified content creators; and
a score assignment engine that assigns a score to each content item that is associated with each content creator.

8. The system of claim 7, further comprising a parser that parses the byline of collected content items.

9. The system of claim 7, further comprising a scraper that scrapes the names of content creators from content items published in online sources.

10. The system of claim 7, the content creator verification engine further comprising an online presence search engine that uses a scraped content creator name to locate a publicly available online presence.

11. The system of claim 7, the content creator verification engine further comprising a link detection engine that detects the presence of outbound links from an online presence to verified content created by the content creator.

12. The system of claim 7, further comprising a matrix generator that generates a matrix based on information contained in the content creator network.

13. The system of claim 7, further comprising a ranking algorithm that calculates a fixed-point score for each creator in the network from the matrix.

14. The system of claim 13, further comprising a filter that pulls content items from the database into a collection ordered by the content items' fixed-point score.

15. A computer software product that includes a medium readable by a processor, the medium having stored thereon a set of instructions for ranking content items by creator endorsements, the instructions comprising:
a first set of instructions which, when loaded a memory and executed by a processor, causes the processor to collect endorsements associated with one or more content creators;
a second set of instructions which, when loaded into memory and executed by the processor, causes the processor to qualify the endorsing entity;
a third set of instructions which, when loaded into memory and executed by the processor, causes the processor to build a creator network from collected endorsements and content creators;
a fourth set of instructions which, when loaded into memory and executed by the processor, causes the processor to apply an endorsement weighting function to the collected endorsements;
a fifth set of instruction which, when loaded into memory and executed by the processor, causes the processor to assign a score to the content creators in the creator network;
a sixth set of instruction which, when loaded into memory and executed by the processor, causes the processor to assign the content creator scores to the content items produced by the content creators; and
a seventh set of instructions which, when loaded into memory and executed by the processor, causes the processor to order a collection of content items based on the items' assigned scores.

16. The computer implemented software product of claim 15, wherein verifying content creators' identities includes matching content creators in a database to a publicly available online profile.

17. The computer implemented software product of claim 15, wherein building the content creator network includes entering content creators and collected endorsements into a graph in the form of edges and nodes.

18. The computer implemented software product of claim 15, wherein analyzing information contained in the creator network includes entering that information into a matrix.

19. The computer implemented software product of claim 15, wherein the endorsement weighting function is a non-decreasing function of the number of endorsements made.
